(19) United States
(12) Patent Application Publication
(10) Pub. No.: US 2010/0101489 A1
(43) Pub. Date: Apr. 29, 2010

(54) PAINTING INSTALLATION

(76) Inventor: Gerd Wurster, Stuttgart (DE)

Correspondence Address: BRACEWELL & GIULIANI LLP, P.O. BOX 61389, HOUSTON, TX, 77208-1389, US

(21) Appl. No.: 12/529,353

(22) PCT Filed: Feb. 11, 2008
(86) PCT No.: PCT/EP2008/001012

§ 371 Date: Dec. 28, 2009

(30) Foreign Application Priority Data
Mar. 2, 2007 (DE) 10 2007 011 602.2
May 23, 2007 (DE) 10 2007 015 150.2

(51) Int. Cl. B05B 15/12; F24F 11/00

(52) U.S. Cl. 118/326; 454/53; 454/54

(57) ABSTRACT

The invention provides a painting installation comprising a spray booth having an application zone in which parts are to be painted, at least one auxiliary zone being separated from said application zone, an air supply and an air exhaust system having a first air supply and a second air supply, an air-conditioning device, at least one baffle element being arranged between said application zone and said at least one auxiliary zone, wherein said first air supply is provided for said application zone and is conducted via said air-conditioning device, said second air supply is provided for said auxiliary zone and is separated from said air-conditioning device, said at least one baffle element is configured for optimizing the air flow conditions in the transition area between said application zone and said auxiliary zone, wherein said exhaust air from said spray booth is recycled and at least partially fed to said air-conditioning device, and wherein said application zone is supplied only with air-conditioned air via said air-conditioning device, while said auxiliary zone is supplied with air that is not air-conditioned or only partially air-conditioned.

### CROSS-REFERENCES TO RELATED APPLICATIONS

This application is a continuation of International Patent Application PCT/EP2008/001012, filed on Feb. 11, 2008 designating the U.S., which international patent application has been published in German language and claims priority from German patent application 10 2007 011 602.2, filed on Mar. 2, 2007 and from German patent application 10 2007 015 150.2, filed on Mar. 23, 2007, the entire content of which is fully incorporated by reference herewith.

### BACKGROUND OF THE INVENTION

For high-quality spray painting results, the spray booths of spray-painting systems usually are air-conditioned. Air-conditioning requires that the air be cooled down for eliminating humidity in the air and be then heated up again to operating temperature. Due to the high air flow rates required this results in considerable air consumption.

### SUMMARY OF THE INVENTION

In view of this it is a first object of the present invention to disclose a painting installation which ensures an energy efficient consumption.

It is a second object of the invention to disclose a painting installation which reduces environmental pollution.

It is a third object of the invention to disclose a method of painting parts in a painting installation that allows for an energy efficient process with low environmental pollution.

These and other objects of the invention are achieved by a painting installation comprising a spray booth having an application zone in which parts are to be painted, at least one auxiliary zone separate from the application zone, an air supply and an air exhaust system, wherein a first air supply is provided for the application zone and is directed via an air-conditioning device and wherein a second air supply, separate from the air-conditioning device, is provided for the auxiliary zone.

The object of the invention is thus perfectly achieved.

According to the invention only the application zone of the spray booth, where the spray-painting operation as such is carried out, is supplied with conditioned supply air whereas the other auxiliary zones of the spray booth, where additional appliances, such as painting robots, lifting appliances or the like are accommodated, are supplied with unconditioned supply air. In this way, the volume of conditioned air can be considerably reduced compared with the fully air-conditioned systems usual in the art, which leads to corresponding energy savings.

The term “air-conditioning” as used in the context of the present invention relates to an air-conditioning process which in any case includes a cooling step and an accompanying dehumidification process. The term does not cover simple “air-conditioning”, for example heating-up or mixing the air with other air.

Air-conditioning is regarded as being necessary if really good painting results are to be achieved.

According to another embodiment of the invention, at least one baffle element is provided between the application zone and the at least one auxiliary zone for optimizing the air flow conditions in the transition area between application zone and auxiliary zone.

It is possible in this way to reduce turbulences which necessarily occur due to differences in air density, humidity content or temperature of the adjoining air flows being brought together.

According to another embodiment of the invention, exhaust air from the spray booth is re-circulated, at least in part, via at least one separator, and at least part of the re-circulated air is directed to an exhaust air cleaning device, for example in the form of a thermal after-burner, preferably a regenerative after-burner or a solvent reclaiming device.

In cases where solvent-based lacquers are used, upgrading of the solvents to a range of approximately 10 g/m³ (typically approximately 3 g/m³) and suitable exhaust air cleaning by thermal after-burning are facilitated in this way.

According to another embodiment of the invention, the second air supply system draws in recycled air from the spray booth, at least in part.

This allows the advantages connected with the upgrading process to be utilized for the application zone.

According to an alternative embodiment of the invention, the second air supply can also be effected using environmental air or fresh air, at least in part.

The energy savings realized by the invention are achieved in this case as well.

According to another embodiment of the invention, a partition wall, provided with an application opening for the spraying application, is disposed between the application zone and the auxiliary zone.

That feature provides the advantage that an operator can be positioned in the auxiliary zone and can be supplied with separate supply air, preferably with fresh air. The spraying application can be suitably carried out through the application opening.

In that case, a pressure drop preferably occurs between the auxiliary zone and the application zone, which gives rise to an air flow from the auxiliary zone to the application zone.

The operator in the auxiliary zone is protected in this way from a higher concentration of noxious matter in the flow of re-circulated air in the application zone.

According to a further alternative embodiment of the invention, the spray booth comprises a separate, preferably movable operator booth which is connected with the application zone via an application opening.

That embodiment is of special advantage in painting large parts. The movement of the operator booth may be effected, for example, in vertical direction and/or in horizontal direction or as a turning movement.

The partition wall between the application zone and the auxiliary zone is movable according to another embodiment of the invention.

Also, the application opening may be variable or movable.

One thereby achieves improved flexibility.

As has been mentioned before, the second air supply system for the auxiliary zone may be supplied with fresh air, at least in part.

This is of advantage especially when the auxiliary zone is intended to be accessed by an operator.

According to an additional further development of the invention, filters of different grades may be provided for the air-conditioning device and for the air supply for the auxiliary zone, i.e. preferably filters of finer grades for the air-conditioning device and filters of coarser grades for the second air supply system for the auxiliary zone.

For example, grades F5 and F9 (according to DIN EN 1822) may be used for the air-conditioning device whereas grade F5 may be used for the auxiliary zone.

This reduces the pressure loss caused by the filters in the auxiliary zone and thus saves energy and filter costs.

According to another embodiment of the invention, a monitoring device is provided for monitoring the solvent concentration.

This helps reduce the air volume required for the exhaust air cleaning device still further to the degree necessary to guarantee compliance with a specified maximum solvent concentration.

According to another embodiment of the invention, a control device is provided for controlling the proportion of air that is directed to the exhaust air cleaning device.

In that case, the proportion of air directed to the exhaust air cleaning device is preferably controlled as a function of the solvent concentration in the area of the second air supply.

One reduces in this way the amount of exhaust air supplied to the exhaust air cleaning device (for example a regenerative after-burning device) to the amount necessary. This leads to additional energy and cost savings.

In addition, this provides the possibility to control the solvent concentration in the air supplied to the exhaust air cleaning device to ensure that the solvent concentration is maintained between 2 and 20 g/m³, preferably between 2 and 10 g/m³, more preferably between 2 and 5 g/m³.

In this way, exhaust air cleaning can be effected by regenerative after-burning, in autothermic operation, which means that the solvents contained in the exhaust air will alone suffice to keep the burning process going. With the result that an especially energy-saving process is rendered possible.

In case of a sufficiently high solvent concentration of, for example, 10 g/m³, the exhaust air, instead of being after-burnt, may also be directed through a “cold trap” where the solvent portion can be separated by condensation.

This is an especially low-cost solution and provides the advantage that the condensate is available for being reused.

According to another embodiment of the invention, the monitoring device is designed for measuring the solvent concentration and the control device comprises a valve that is controlled in response to the solvent concentration. The valve may consist, for example, of a controllable flap or a controllable fan.

This allows the exhaust air being supplied to the exhaust air cleaning device to be controlled in a simple and precise way.

According to an alternative embodiment of the invention, the monitoring device is designed for monitoring the quantity of solvent introduced, and the control device is designed for controlling the proportion of exhaust air, that is supplied to the exhaust air cleaning device, in response to the quantity of solvent introduced.

Monitoring the solvent quantity may be based, for example, on the volume of liquid sprayed in the spraying booth.

It is then possible to do without a solvent sensor, which leads to an especially simple and low-cost construction.

According to another embodiment of the invention, the spray booth is closed off from the outside by doors and inlet and outlet locks.

That feature helps reduce the quantity of exhaust air still further. For long parts, there is the possibility to install double doors upstream and downstream of the spray booth.

In that case, the double doors preferably are coupled with a lock in such a way that only an outer door or an inner door can be opened at any time.

According to another embodiment of the invention, the painting installation according to the invention comprises a spray booth having an application zone where parts are to be painted, an air supply and an air exhaust system, a conveyor intended to transport parts through the spray booth, and an inlet lock and an outlet lock, wherein the locks are configured as channels connected with the interior of the spray booth and extend obliquely in upward direction to the outside.

Such an embodiment of the invention leads to energy savings even in case the spray booth is not provided with separate air circuits for an application zone and an auxiliary zone.

Conventional continuously operating spray booths usually use horizontal conveyors. No special measures are taken, neither at the inlet nor at the outlet ends, to ensure separation between the air-conditioned atmosphere in the booth and the unconditioned environmental air. This leads to considerable energy losses at the inlet and at the outlet. In addition, there are the risks of solvent losses and of contaminations being introduced.

According to the invention, the special design of the locks at the inlet and at the outlet considerably reduces the air volumes introduced through the locks so that the total air exchange is reduced, with the corresponding savings in energy and costs.

One utilizes in this case the fact that the conditioned air in the spray booth is normally cooler and, accordingly, heavier than the environmental air. As a result, the volume of air that is taken in and discharged through the locks is clearly reduced.

It is also possible to arrange a plurality of spray booths in series, which then are coupled by a channel with a conveyor extending through that channel. In that case, an inlet lock is provided at the inlet end of the first spray booth and an outlet lock is provided at the outlet end of the last spray booth.

According to another embodiment of the invention, each lock is closed off to the outside by a lower edge, that lower edge extending at a level at least as high as the level of the conveyor, at which the conveyor moves through the spray booth.

One thereby obtains an especially efficient reduction of the air exchange volumes occurring at the locks.

According to another embodiment of the invention, the air conditioning devices or ventilation devices are provided with filters that can be passed by the air in vertical direction.

Compared with the horizontal installation of filters usual in the art, this allows considerable costs to be saved because in that case the filters can be installed from the top without any need for special reinforcements of the kind required for horizontally installed filters.

It is understood that the features of the invention mentioned above and those yet to be explained below can be used not only in the respective combination indicated, but also in other combinations or in isolation, without leaving the scope of the invention.

### BRIEF DESCRIPTION OF THE DRAWINGS

Further features and advantages of the invention will become apparent from the description that allows of certain preferred embodiments, with reference to the drawing. In the drawing

FIG. 1 shows a diagrammatic representation of a first embodiment of a painting installation according to the invention;

FIG. 2 shows a variant of the painting installation of FIG. 1;

FIG. 3 shows another embodiment of a painting installation according to the invention;

FIG. 4 shows a greatly simplified diagrammatic top view of a spray booth according to the invention, taken from above;

FIG. 5 shows a cross-sectional representation of another embodiment of a spray booth according to the invention;

FIG. 6 shows another variant of the painting installation of FIG. 3;

FIG. 7 shows another variant of the painting installation of FIG. 1;

FIG. 8 shows a partial sectional view of a detail of the spray booth with continuous conveyor as illustrated in FIG. 1, in the area of an inlet lock;

FIG. 9 shows another embodiment of a painting installation with two spray booths connected in series, provided with an inlet and an outlet lock;

FIG. 10 shows another variant of a spray booth according to the invention with two locks protected by double doors;

FIG. 11 shows a simplified representation of a filter for an air-conditioning device or a ventilation device according to FIG. 1, designed as surface filter for being passed by air flowing in vertical direction; and

FIG. 12 shows a simplified representation of a filter for an air-conditioning device or a ventilation device according to FIG. 1, designed as bag filter for being passed by air flowing in vertical direction.

### DESCRIPTION OF THE PREFERRED EMBODIMENTS

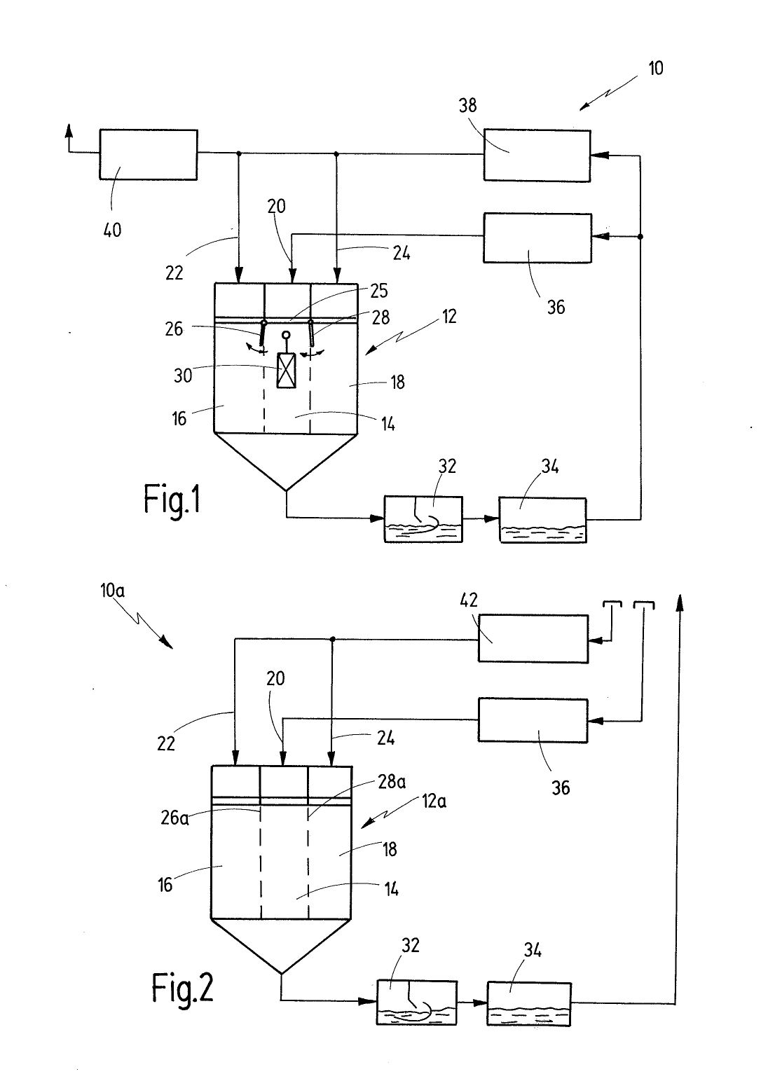

A first embodiment of the painting installation according to the invention is indicated generally by reference numeral 10 in FIG. 1.

The painting installation comprises a spray booth 12, divided into three zones, namely a central application zone 14, where parts 30 are spray-coated, and two lateral auxiliary zones 16, 18 where auxiliary painting equipment, for example robots, painting appliances or the like, are arranged.

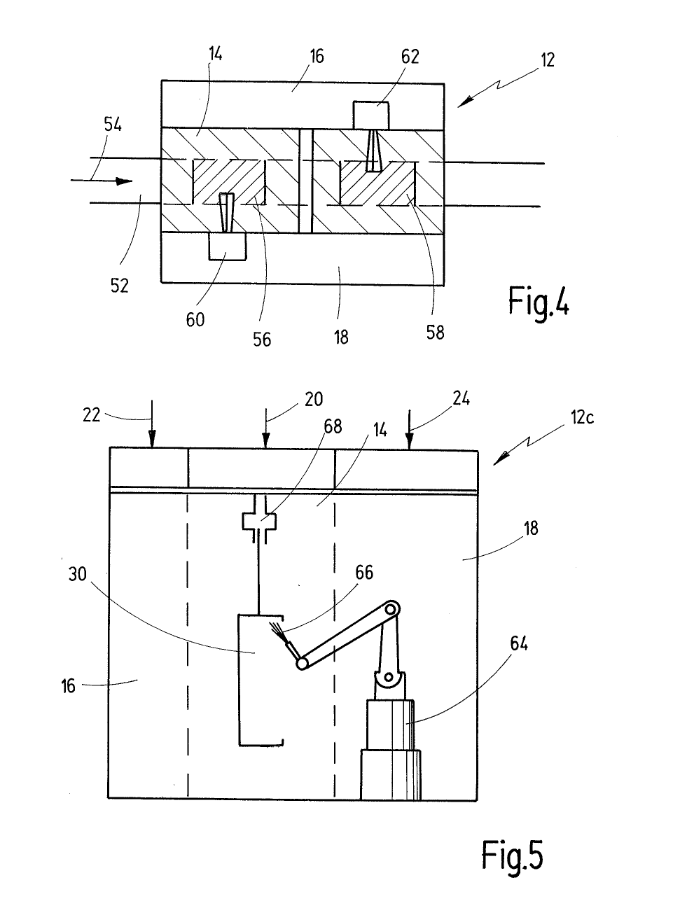

Details of the transition between the application zone 14 and the auxiliary zones 16, 18, respectively, can be seen in FIG. 4, by way of example. There is provided a first corridor 52, which extends through the spray booth 12 in lengthwise direction and through which parts 30 can be transported along a path defined by a conveyor, as indicated by arrow 54. Inside the spray booth 12 there are provided two robots 60, 62, one of them 60 located in the auxiliary zone 18, a second one 62 located in the auxiliary zone 16. Illustrated in broken lines in FIG. 4 are a first application area 56 within the corridor, which is served by the robot 62, and a second application area 58 served by the robot 62. These application areas 56, 58 are located within an auxiliary zone 14 and are supplied with conditioned supply air (see FIG. 1) from above, via a separate air supply 20 that passes through an air-conditioning device 36. The remaining auxiliary zones 16, 18, in which the robots 62, 64 and, in certain cases, auxiliary appliances are accommodated, are supplied with separate intake air via a separate air supply 22 and 24, respectively, the latter air being introduced via a recirculation device 38 illustrated in FIG. 1.

That separate supply of air to the application zone 14 and to the auxiliary zones 16, 18 allows the energy-intensive air-conditioning process in the application zone 14 to be limited to the air volume actually required, while the remaining zones of the spray booth, designated as auxiliary zones 16, 18, are supplied with separate air which is conditioned either not at all or only in part. A corresponding recirculation device 38 is shown by way of example in FIG. 1.

The recirculation device 38, through which air is supplied to the air supply 22, 24 of the auxiliary zones 16, 18, comprises as a rule a blower, a filter and, if necessary, an accessory heating system.

The supply air separately supplied to the spray booth 12, at 20, 22 and 24, enters the interior of the spray booth 12 from above, via intake surfaces indicated by 25 in FIG. 1. As is known from the prior art, such intake surfaces may be configured as filter ceilings, for example, or else as grids, nozzles, perforated plates, or the like. In that case, suitable materials are selected to ensure uniform distribution of the air.

The intake surfaces 25 are followed, in the transition areas between the application zone 14 and the auxiliary zones 16, 18, by baffle surfaces 26, 28 illustrated as movable flaps in FIG. 1. By suitably adjusting the baffle surfaces 26, 28 it is possible to minimize turbulences that may arise as a result of differences in air properties in the application zone 14 and the auxiliary zones 16, 18, respectively. Preferably, the supply air introduced into the application zone 14 and into the auxiliary zones 16, 18 from the air-conditioning device or from the recirculation device is suitably controlled to obtain uniform or similar air velocities. In addition, care is taken to obtain, to the extent possible, uniform temperatures and small differences in air density in order to achieve, to the extent possible, a uniformly directed, laminar flow through the spray booth, from the top to the bottom. This allows spray-coating results of high quality to be achieved.

The exhaust air from the spray booth 12 is recycled and passed for that purpose through a washer 32 (for example a venturi washer) and a rewasher 34. From the rewasher 34 the exhaust air enters the air-conditioning device 36 where it is conditioned to the desired temperature and relative humidity. Another part of the exhaust air is directed to the recirculation device 38 which directs the supply air 22, 24 to the auxiliary zones 16, 18. Following the recirculation device 38, part of the exhaust air is branched off and supplied to an exhaust air cleaning device, preferably in the form of a thermal after-burning system, for being then given off to the environment as exhaust air, preferably free from noxious matter.

The air-conditioning device 36 used is known in principle in the art. As a rule, it comprises a prefilter, a cooler for dehumidification, a heater and a blower. Further, a suitable control is provided to adjust the air supplied to the spray booth to a suitable temperature (for example 24° C.) and a suitable relative humidity (for example 65%).

Instead of the before-mentioned usual air-conditioning process using venturi separation, air-conditioning may also be effected by dry separation.

One embodiment of a painting installation according to the invention, which is slightly modified compared with the one illustrated in FIG. 1, is illustrated in FIG. 2 and indicated generally by reference numeral 10a. In that Figure, just as in the Figures that follow, corresponding reference numerals are used for designating corresponding parts.

The painting installation 10a comprises a spray booth 12a that differs from the spray booth 12 discussed with reference to FIG. 1 only in that the baffle surfaces 26a, 28a between the application zone 14 and the auxiliary zones 16, 18 have a rigid design.

Further, the spray booth 12a is not supplied with exhaust air, as in the case of the embodiment described before, but with environmental air, via an air-conditioning device 36 and/or via a supply air device 42.

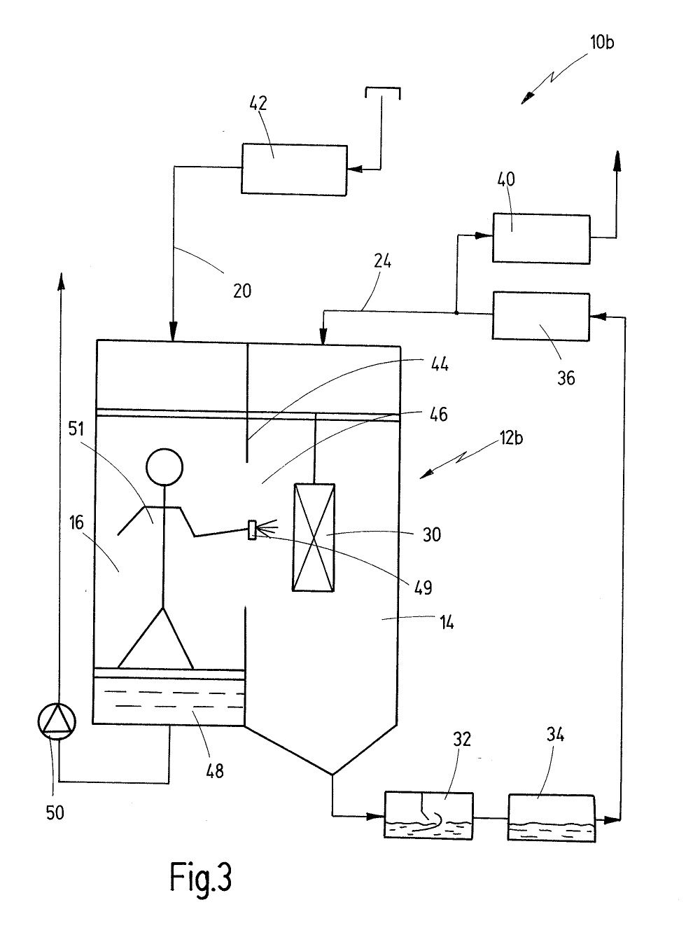

FIG. 3 shows another variant of a painting installation indicated generally by reference numeral 10b.

The spray booth 12b comprises an application zone 14 and an auxiliary zone 16, separated one from the other by a partition wall 44, with an application opening 46 provided in the partition wall 44. Parts 30 located in the application zone 14 can be spray-coated by an operator 51 positioned in the auxiliary zone 16 using a spray gun 49.

The air supply 24 for the application zone 14 is again ensured via an air-conditioning device 36. In contrast, the air supply 20 for the auxiliary zone 16 is ensured using fresh air, via a supply air device 42. Preferably, a pressure drop is adjusted between the auxiliary zone 16 and the application zone 14 so that the operator 51 is protected from air loaded with noxious matter, by an air flow entering the application zone 14 from the application zone 14. Downstream of the air-conditioning device 36, an additional thermal after-burning process 40 is preferably provided to permit the solvent-loaded re-circulated air to be cleaned and then discharged to the environment. The flow of supply air for the auxiliary zone 16, which is realized via the supply air device 42, may be selected to correspond to the flow of exhaust air discharged via the thermal after-burning installation. For example, the thermal after-burning installation 40 may be designed for 500 m³/hr. and the same air volume may be introduced into the auxiliary zone 16 via the supply air device 42. In the lower area of the auxiliary zone 16 a dry separation system 48 may be provided to allow the exhaust air to be discharged to the environment via a blower 50.

However, there is also the possibility to do without any exhaust air for the auxiliary zone 16, provided the complete supply air introduced is directed into the application zone 14 via the application opening 46.

The auxiliary zone 16 may also be configured as a ventilated hall, in which the operator is placed and which communicates with the application zone 14 via the application opening 46.

FIG. 5 shows an embodiment of the spray booth, which has been slightly modified relative to the one illustrated in FIG. 4 and is indicated generally by reference numeral 12c.

A robot 46 illustrated in the auxiliary zone 18 serves to paint parts 30 that are transported through the application zone 14 using a conveyor 68.

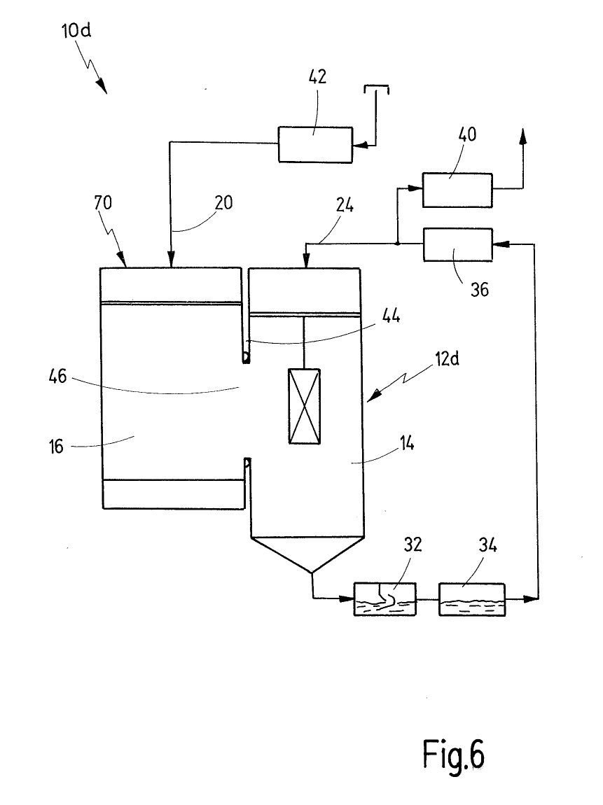

A variant of the painting installation discussed before with reference to FIG. 3 is illustrated in FIG. 6 and indicated generally by reference numeral 10d.

The only difference over the embodiment illustrated in FIG. 3 consists in that the spray booth 12d comprises a movable operator booth 70 in which an auxiliary zone 16 is provided for the operator. The movable operator booth 70 comprises an application opening 46 through which it communicates with the application zone 14. The operator booth 70 has no exhaust air system of its own. The operator booth 70 may be moved in vertical direction and/or in horizontal direction, for example, the application opening 46 being coupled with the application zone 14 via suitable closing means and seals.

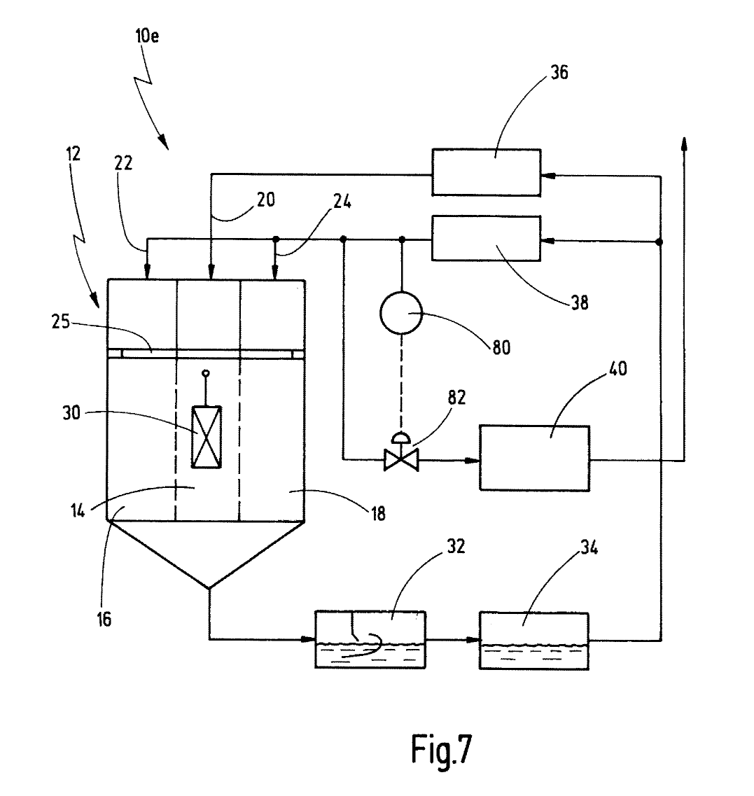

In FIG. 7, another embodiment of a painting installation according to the invention, slightly modified relative to the one illustrated in FIG. 1, is illustrated and indicated generally by reference numeral 10e.

The painting installation 10e comprises a spray booth 12 with an application zone 14 and two auxiliary zones 16, 18, as illustrated in FIG. 1. Just as in FIG. 1, the application zone is supplied via a supply air device 20 from an air-conditioning device 36, while the auxiliary zones 16, 18 are supplied by a separate air supply 22, 24 from a re-circulation system 38. Both the air-conditioning device 36 and the re-circulation system 38 are supplied with the—partly re-circulated—exhaust air from the spray booth 12, which is cleaned by a washing device 32 and a re-washer 34. In contrast to the embodiment illustrated in FIG. 1, the solvent concentration of the air supplied to the auxiliary zones 16, 18 from the re-circulation system 38 via the air supply 22, 24 is monitored and the portion of air which is directed to the thermal after-burning system 40 is controlled in response to the solvent concentration through a valve 42 that can be controlled automatically. For the rest, the embodiment corresponds to the one illustrated in FIG. 1.

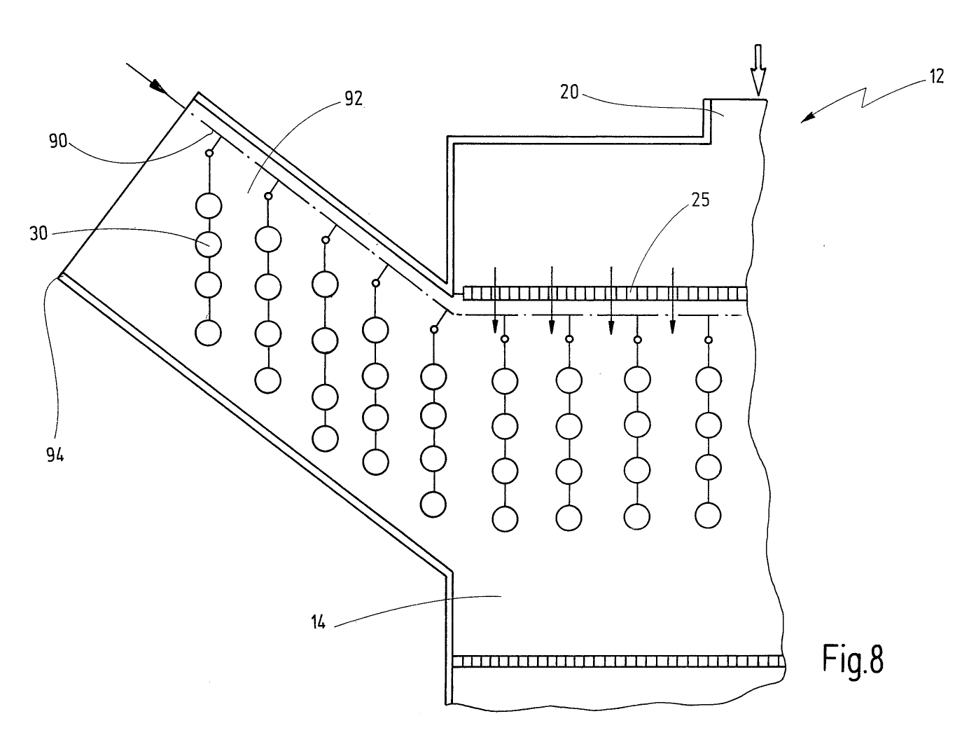

FIG. 8 shows an enlarged partial longitudinal section through the inlet area of the spray booth according to FIG. 1. The sectional line extends in this case directly through the application zone 14. The spray booth, being designed in this case as continuously operating booth, comprises an inlet lock 92 and an outlet lock (not shown) of identical configuration. The inlet lock 92 and the outlet lock are configured as channels that arrive obliquely from above, opening into the interior of the spray booth 12. A conveyor 90 extends in parallel along the upper inner surface of the inlet lock 92, i.e. obliquely from above into the spray booth 12. Inside the spray booth 12, the conveyor 90 extends horizontally, immediately below the intake areas 52. At the outlet end, the conveyor 90 again extends in parallel along the upper inner surface of the outlet lock, obliquely in upward direction.

The lower edge 94 of the inlet lock 92 (and, correspondingly, of the outlet lock as well) is positioned at the highest possible level, preferably at least at the level of the conveyer 90 inside the spray booth 12.

Due to that high arrangement of the inlet and outlet locks the air, being colder and heavier as a result of the air-conditioning process, accumulates inside the lock 92 or the spray booth 12 so that any entry of warmer air from the outside is clearly reduced. This considerably reduces the exchange of air at the openings of the locks 92, whereby the required air throughput is clearly reduced. This is of course true irrespective of whether the spray booth 12 comprises a separately supplied application zone 14 and auxiliary zones 16, 18, as described before, or whether the spray booth 12 is air-conditioned entirely.

FIG. 9 shows a variant of the embodiment according to FIG. 8. In that case, two spray booths 12, 12e are provided in series and are coupled by a channel 97, with a conveyor extending in that channel. An inlet lock 92 according to FIG. 8 is provided at the inlet end of the first spray booth 12, while an outlet lock 96 according to FIG. 8 is provided at the outlet end of the second spray booth 12e.

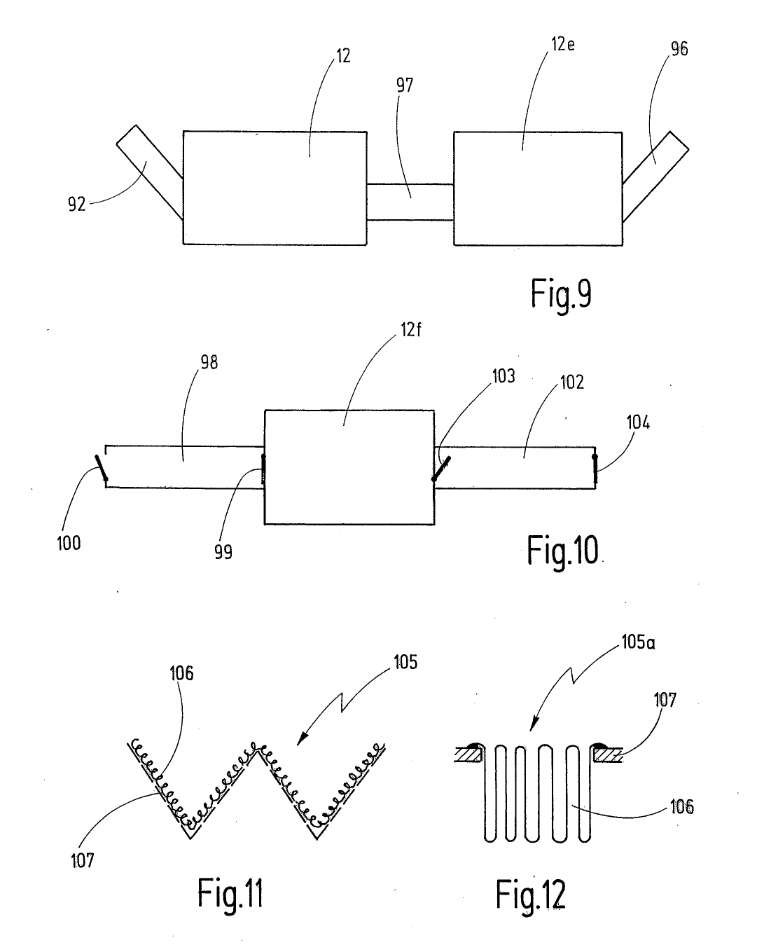

FIG. 10 illustrates a spray booth 12f, which is connected with a first lock 98 on a first end and a second lock 102 on the opposite end. The spray booth 12f and the lock 98 or 102 are provided with doors 99, 100 or 103, 104, respectively, which are suitably controlled to ensure that only one outer door 100, 104 or one inner door 99, 103 can be opened at any time. As a result, the exchange of air is minimized.

FIG. 11 shows a simplified illustration of a detail of a surface filter for the air-conditioning device 36 or the re-circulation system 38 according to FIG. 1. The filter consists of a surface filter using a filter material 106, also positioned on a supporting surface 107, through which air is permitted to flow in vertical direction.

Due to the vertical arrangement lesser reinforcement measures are required than for the horizontal arrangement usual in the prior art. In addition, lacquer residues can flow off or drip off to the bottom more easily.

FIG. 12 shows an embodiment of such a filter 105a in the form of a pocket filter or bag filter 106 which is held on a holder 107 and, simultaneously, in a holder 107.

What is claimed is:

1. A painting installation comprising:
a spray booth having an application zone for painting parts therein;
at least one auxiliary zone being separated from said application zone by at least one baffle element;
an air-conditioning device having an input end and an output end;
a recirculation device having an input end and an output end;
an air cleaner for cleaning exhaust air from said spray booth;
wherein said output end of said air-conditioning device is connected with said application zone for supplying air-conditioned air thereto;
wherein said output end of said recirculation device is connected with said auxiliary zone for supplying air thereto;
wherein an output end of said air cleaner is connected with said input end of said air-conditioning device and is connected with said input end of said recirculation device for feeding air thereto; and
wherein said at least one baffle element is arranged for optimizing air flow conditions in a transition area between said application zone and said auxiliary zone.

2. The painting installation of claim 1, further comprising an exhaust air cleaning device selected from the group consisting of a thermal after-burner and a solvent reclaiming device;
wherein said exhaust air cleaning device has an input end which is connected to an output end of said recirculation device.

3. A painting installation comprising:
a spray booth having an application zone for painting parts therein;
at least one auxiliary zone being separated from said application zone by at least one baffle element;
an air-conditioning device having an input end and an output end;
a recirculation device having an input end and an output end;
an air cleaner for cleaning exhaust air from said spray booth;
wherein said output end of said air-conditioning device is connected with said application zone for supplying air-conditioned air thereto;
wherein said output end of said recirculation device is connected with said auxiliary zone for supplying air thereto; and
wherein an output end of said air cleaner is connected with said input end of said air-conditioning device for feeding air thereto, or is connected to the outside.

4. The painting installation of claim 3, wherein said at least one baffle element is designed as a movable flap.

5. The painting installation of claim 3, wherein said input end of said recirculation device is connected with said output end of said air cleaner.

6. The painting installation of claim 3, wherein said input end of said recirculation device is connected to the outside for feeding fresh air thereto.

7. The painting installation of claim 3, wherein said air cleaner comprises at least one selected from the group consisting of a washer and a separator.

8. The painting installation of claim 3, further comprising an exhaust air cleaning device selected from the group consisting of a thermal after-burner and a solvent reclaiming device;
wherein said exhaust air cleaning device has an input end which is connected to an output end of said air cleaner, or is connected to an output end of said recirculation device.

9. The painting installation of claim 8, further comprising:
a monitoring device for monitoring a solvent concentration at said output end of said recirculation device;
a control device comprising a valve and being configured for controlling a proportion of air that is directed to said exhaust air cleaning device depending on said solvent concentration.

10. The painting installation of claim 9, wherein said monitoring device is configured for monitoring a quantity of solvent introduced, and wherein said control device is configured for controlling a proportion of exhaust air, which is supplied to said exhaust air cleaning device, in response to said quantity of solvent introduced.

11. The painting installation of claim 9, wherein said control device is configured for maintaining said solvent concentration in a range of between 2 and 20 g/m³, and wherein said exhaust air cleaning device comprises a cold trap configured for condensing of solvent.

12. The painting installation of claim 9, wherein said spray booth comprises at least one lock for closing off from the outside;
wherein said at least one lock comprises double doors being configured such that only an outer door or an inner door can be opened at any time.

13. The painting installation of claim 9, further comprising a controller for controlling air flow into said application zone and into said auxiliary zone such that a pressure drop is encountered between said application zone and said auxiliary zone for effecting an air flow from said auxiliary zone to said application zone.

14. The painting installation of claim 3, wherein filters of different grades are provided for said air-conditioning device and for said air supply for said auxiliary zone, wherein said air-conditioning device comprises filters of finer grades and said second air supply comprises filters of coarser grades.

15. A painting installation comprising:
a spray booth having an application zone for painting parts therein;
at least one operator booth being separated from said application zone by a wall and being connected to said application zone by an application opening provided within said wall;
an air-conditioning device having an input end and an output end;
a supply air device;
an air cleaner for cleaning exhaust air from said spray booth;
wherein said output end of said air-conditioning device is connected with said application zone for supplying air-conditioned air thereto;
wherein an output end of said supply air device is connected with said operator booth for supplying environmental air thereto;
wherein an output end of said air cleaner is connected with said input end of said air-conditioning device for feeding air thereto.

16. The painting installation of claim 15, wherein said air cleaner comprises at least one selected from the group consisting of a washer and a separator.

17. The painting installation of claim 15, wherein said operator booth is arranged movably with respect to said application zone.

18. The painting installation of claim 15, further comprising an exhaust air cleaning device selected from the group consisting of a thermal after-burner and a solvent reclaiming device;
wherein said exhaust air cleaning device has an input end which is connected to an output end of said air cleaner, or is connected to an output end of said air-conditioning device.

19. The painting installation of claim 18, further comprising:
a monitoring device for monitoring a solvent concentration at an output end of said air cleaner;
a control device comprising a valve and being configured for controlling a proportion of air that is directed to said exhaust air cleaning device depending on said solvent concentration.

20. The painting installation of claim 15, further comprising a conveyor extending through an inlet lock into said spray booth and through an outlet lock out of said spray booth, each of said locks having a lower edge for closing off to the outside, said lower edge being arranged on a level higher than a level at which said conveyor extends through said spray booth.
